(19) United States
(12) Patent Application Publication
(10) Pub. No.: US 2025/0385789 A1
(43) Pub. Date: Dec. 18, 2025

(54) APPARATUSES, SYSTEMS, AND METHODS FOR INTRA-MODULE AUTHENTICATION

(71) Applicant: Micron Technology, Inc., Boise, ID (US)

(72) Inventors: Lance W. Dover, Boise, ID (US); Matthew A. Prather, Boise, ID (US); Sujeet Ayyapureddi, Boise, ID (US)

(73) Assignee: Micron Technology, Inc., Boise, ID (US)

(21) Appl. No.: 18/970,687

(22) Filed: Dec. 5, 2024

Related U.S. Application Data
(60) Provisional application No. 63/661,414, filed on Jun. 18, 2024.

(51) Int. Cl. H04L 9/08; G06F 7/58

(52) U.S. Cl. CPC H04L 9/0869; G06F 7/588

(57) ABSTRACT

A memory module includes one or more memory devices and a module logic chip. The module is coupled to a host which operates the memory devices. Certain features of the module may only be accessible once the module has authenticated with the host. For example, the module logic chip may perform asymmetric authentication with the host and the feature may be enabled only after successful authentication. In some embodiments, the module logic may additionally authenticate the memory devices. For example, the module logic chip may perform symmetric authentication on the memory devices after authentication with the host.

### CROSS-REFERENCE TO RELATED APPLICATIONS

This application claims the filing benefit of U.S. Provisional Application No. 63/661,414, filed Jun. 18, 2024. This application is incorporated by reference herein in its entirety and for all purposes.

### BACKGROUND OF THE INVENTION

Memory devices are used to store information. Multiple memory devices may be packaged together, for example in the form of a module. Certain operations or features of the memory devices may have a heightened security, for example because they may reveal sensitive information about the memory or its operation when enabled. In order to prevent unauthorized access to such operations or features, it may be useful to confirm that the memory devices remain connected to an authorized memory package or module.

### BRIEF DESCRIPTION OF DRAWINGS

FIG. 1 is a block diagram of a memory system according to some embodiments of the present disclosure.

FIG. 2 is a block diagram of a semiconductor device according an embodiment of the disclosure.

FIG. 3 is a block diagram of module authentication logic according to some embodiments of the present disclosure.

FIG. 4 is a flow chart of a process of generating various values used in authentication operations according to some embodiments of the present disclosure.

FIG. 5 is a flow chart of a method of an intra-module authentication operation according to some embodiments of the present disclosure.

FIG. 6 is a flow chart of a method of intra-module authentication according to some embodiments of the present disclosure.

### DETAILED DESCRIPTION OF THE INVENTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Memory devices store information in a memory array. The array includes a number of memory cells, each of which may generally store a bit of information. The memory cells are organized at the intersection of word lines (rows) and bit lines (columns). Specific memory cells may be accessed (e.g., for read or write operations) based on a row and column addresses which specify one or more word lines and bit lines respectively. The memory devices may include various capabilities, some of which may be optional features which can be enabled/disabled/modified etc. based on various commands and settings.

Memory devices may be packaged together in various ways. A memory module may include a number of memory devices packaged together. The module may then be coupled to the host. Each memory devices may communicate information (e.g., data) back and forth along data terminals to the host. The host may provide other information, such as commands and addresses, to a hub chip or module logic chip packaged on the module, which may distribute the commands and addresses to the memory devices.

Certain features of the memory devices may be determined to be sensitive. For example, the memory devices may generally perform on-die error correction operations based on error correction information stored on the device along the device. During normal operations, the error correction information may remain entirely on the device. However, in certain modes the memory devices may instead provide the error correction information to the host. This may reveal details of the device's error correction operation and/or information about the error rate or other measured error characteristics. It may be desirable to ensure sensitive features, such as ECC pass-through, are only enabled when the memory devices are connected to an authorized host. However, conventional memory devices may lack sufficient capabilities to directly authenticate with the host. There may thus be a need to authenticate the connection between the memory devices and the module they are packaged on using a technique that is more suitable for the memory devices, and authenticate between the module and the host using a more robust authentication protocol.

It may be useful to use encryption as part of performing the authentication, in order to help ensure that the authentication process is difficult for non-authorized devices to duplicate. However, the different chips of the module may have different capabilities. The memory devices may not have sufficient capability for asymmetric cryptography. For example, the memory devices may have a limited capability to perform random number generation and may thus be limited in the amount of entropy, or the amount of randomness/unpredictability/uniqueness they can introduce into an encryption scheme, which in turn may make the encryption easier to penetrate. However, other chips of the module, such as the module logic chip, may have increased capabilities for performing asymmetric cryptography, such as an increased ability for generating entropy, such as a more complex random number generator circuits. It may thus be useful to have intra-module authentication which leverages the capabilities of the different chips involved in the authentication, such as using symmetric cryptography with the memory devices and asymmetric cryptography between the module and host.

The present disclosure relates to apparatuses, systems, and methods for intra-module authentication. A memory module includes a module logic chip and one or more memory devices packaged together. The module logic circuit and the memory devices may authenticate each other using entropy generated on the module logic and the memory device. The entropy may take the form of a random number, and the module logic chip may generate a first random number and share it with the memory devices, the memory devices may each generate a respective second random number and share it with the module logic chip, and then both the module logic chip and memory devices may use the shared random numbers for authentication. In some embodiments, the module logic chip may be capable of generating more entropy than the memory devices. For example, the module logic chip includes a random number generator circuit which may generate random numbers of a first length while the memory devices may include random number generators which generate random numbers of a second length which is shorter than the first length. In some embodiments, the authentication of the memory devices may be performed responsive to authentication between the module logic circuit and a host device.

In an example intra-module authentication between an example memory device and the module logic chip, both the module logic and the memory device may have been loaded with a secret key in a trusted environment (e.g., at a factory) prior to later authentication. During an authentication operation, the module logic chip generates a first random number using a random number generator circuit of the module logic chip and the memory device generates a second random number using a random number generator circuit of the memory device. The two random numbers are shared such that both the module logic chip and the memory device have copies of both the first and the second random numbers. The combined two random numbers may be thought of together as a shared random number. Both the module logic chip and the memory device use the shared random number and their respective copies of the secret key to generate a shared session key which is used for a particular authentication session. The module logic chip can then challenge the memory device with a payload (e.g., a message) encrypted based on the session key, which can only be decrypted by the memory which has the matching session key. Similarly, the memory device may challenge the module logic circuit with a payload encrypted based on the session key stored on the memory device, which can only be decrypted by the module logic having the matching session key. In this way, the two devices may authenticate each other, based off a shared random number and their shared secret key. Since the module logic chip generates most of the entropy, for example because the first random number is much longer than the second, this may allow for secure authentication with relatively simplistic random number generation capabilities on the memory device.

In an example implementation, the module logic chip generates a first random number using a random number generator and the memory generates a second random number. The first and second random numbers are shared between the devices and combined to form a shared random number. The module logic chip uses the shared random number and the secret key to generate a session key. The memory device uses its own stored secret key and the shared random number to generate a session key. Assuming no errors, the two copies of the session key should match since they were generated from matching secret keys and the same shared random number. The module logic chip may challenge the memory device, for example by generating a third random number and providing it to the memory device. The memory device generates a pseudo-random number based off the third random number, using a pseudo-random number generator circuit of the memory device. The third random number and pseudo-random number are combined and the combined number is used to encrypt a payload (e.g., a message) based off the combined number and the memory's copy of the session key. The payload is sent as a response to the module's challenge, and the combined number is provided as a challenge to the module. The payload and the combined number are sent to the module logic chip, which extracts the original third random number from the combined number to confirm it matches the stored third random number and then also decrypts the payload based on the stored session key and the combined number. If the decryption is successful and the random number extracted from the combined number matches the original third random number, the module logic circuit has authenticated the memory device. Responsive to that authentication, the module logic circuit challenges the memory device by generating a second payload (e.g., a second message) encrypted with the pseudo-random digits received as part of the combined number and the copy of the session key stored on the module logic chip. The second payload and the pseudo-random digits are sent to the memory device. The memory device authenticates that the pseudo-random digits match, and then uses the pseudo-random digits and its stored copy of the session key to decrypt the second payload. If that decryption is successful, then the memory device has authenticated the module logic circuit. Responsive to that authentication, the memory device may take one or more actions, such as enabling a feature or mode of the memory.

As used herein, the term random number refers to a number which is generated in a non-deterministic fashion, and thus represents a ‘true’ random number. The term pseudo-random number refers a number which is generated in a deterministic fashion. For example, a random number generator may generate different numbers even when given the same inputs twice, while a pseudo-random number generator may generate the same number when given the same inputs twice.

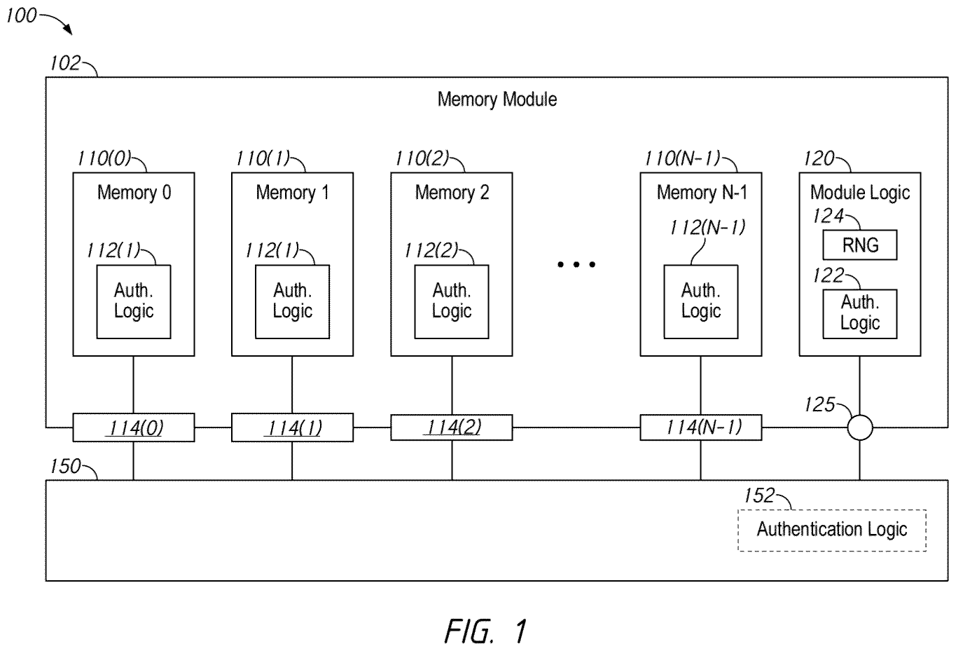

FIG. 1 is a block diagram of a memory system according to some embodiments of the present disclosure. The memory system 100 includes a memory module 102 and a host 150. The memory module 102 includes a number of memory devices 110 and a module logic chip 120. The module 102 may be a DIMM, CMM, or any other macro-functioning system of chips which includes memory devices. The host 150 may be a controller of the module 102, such as a processor (e.g., a CPU or GPU). The module logic chip 120 may be a SPD, power management integrated circuit (PMIC), a register, or a registered clock driver (RCD) or any other chip on the module 102. In some embodiments, multiple module logic chips may be used. For example, normal memory operations may be handled by a first memory chip while a separate chip handles authentication. The term module logic chip will be used to describe any combination of logic circuits and chips coupled to the memory module 102 not including the memory devices 110.

The memory devices 110 each include a memory array which stores information. The memory devices 110 are coupled to the host through respective channels 114. The channels include one or more data terminals which are used to communicate information back and forth between the host 150 and the memory devices 110, for example as part of access operations. The module 102 also is coupled to the host 150 along one or more additional connections, such as a command/address bus and command/address terminals 125, which may be used by the host 150 to operate the module 102. For example, the host 150 may provide an access command (e.g., a write or a read command) as well as row, column, and/or bank addresses along the command/address bus to the command/address terminals 125 as part of an access operation.

In an example access operation, the host 150 provides an access command (e.g., a read or write command) along with addresses along the C/A bus to the C/A terminals 125. The module logic chip 120 distributes the commands and addresses to the memory devices 110 along an internal C/A bus. In an example write operation, the module logic chip 120 receives and distributes a write command along with the addresses. The host 150 provides data along the channels 114 to the targeted memory devices 110. The memory devices write that data to the location(s) specified by the addresses. In some embodiments, the memory devices may generate error correction bits (e.g., parity bits) based on the written data, and write that to the array as well. In an example read operation, the module logic 120 receives a read command and addresses and distributes those to the memory devices 110. The memory devices retrieve the data stored in the memory array at the location(s) specified by the addresses and provide the data along the respective channels 114 to the host 150. In some embodiments, (and when ECC pass-through is disabled, as explained further herein) the devices may perform error correction on the read data based on the data and the error correction bits, and provide the corrected data along the channels 114.

The module 102 includes a module logic circuit 120 which includes an authentication logic circuit 122. The module authentication logic circuit 122 communicates with memory authentication logic circuits 112 of the memory devices 110 to authenticate the connection of the memory devices 110 to the module 102. The module logic chip 120 includes a random number generator (RNG) circuit 124 which is used to generate entropy (e.g., a random number) used by both the module authentication logic circuit 122 and memory authentication logic circuits 112 as part of the authentication operation. The memory devices may also include random number generator circuits (not shown in FIG. 1) which are also used to generate entropy (e.g., a random number) used by both the module authentication logic circuit 122 and the memory authentication logic circuits 112 as part of the authentication operation. In some embodiments, the random number generator 124 may generate much more entropy (e.g., a longer random number) compared to the amount of entropy the memory devices 110 can generate. The intra-module authentication (e.g., between the module authentication logic circuit 122 and memory authentication logic circuits 112) may use symmetric cryptography based on the random numbers generated by the RNG circuit 124 of the module logic chip 120 and the memory devices 110.

In an example implementation, in symmetric authentication, the module authentication logic circuit 122 and each of the device authentication logic circuits 112 may include a secret key. The secret key may be loaded onto the memory devices 110 and module logic chip 120 in a trusted environment such as in a factory when the module is assembled. During an authentication operation, an authentication message may be encrypted based on the secret key and sent to the other device, which may authenticate it by determining if the message can be decrypted with the secret key stored on that device. For example, the module authentication logic circuit 122 may generate an encrypted message and provide it to one or more of the memory authentication logic circuits 112 or the memory authentication logic circuits 112 may generate an encrypted message and provide it to the module authentication logic circuit 122. In some embodiments, the module authentication logic circuit 122 and memory authentication logic circuits 112 may all share a same secret. In some embodiments, the memory authentication logic circuits 112 may each store different secrets, and the module authentication logic circuit 122 may store a number of different secrets, each of which matches with the secret of one memory device. In some embodiments, a session key unique to each authentication operation may be generated based on the secret keys, and the session key may be used to encrypt and decrypt messages for that authentication operation.

In some embodiments, authentication between host 150 and module 102 may also be performed. For example, the authentication logic circuit 122 may also communicate with an authentication logic circuit 152 of the module to authenticate the host 150. The host authentication logic circuit 152 and the module authentication logic circuit 122 may perform authentication using a different protocol than the one used for intra-module authentication. For example, the host/module authentication may use asymmetric cryptography, such as public-key encryption, Rivest-Shamir-Adleman (RSA) encryption, elliptic curve, or combinations thereof. For example, the two authentication logic circuits 122 and 152 may each include a respective private key and a related public key. The public key may be information which can be retrieved (e.g., read) by an outside party. For example the host 150 may retrieve the module authentication logic circuit's 122 public key, and the module authentication logic circuit 122 may retrieve the host authentication logic circuit's 152 public key. The two private keys may remain protected in their respective devices. The two authentication logic circuits 122 and 152 may communicate a challenge back and forth in order to determine if the challenge message encrypted with the recipient's public key can be decrypted with the private key. By sending such messages back and forth, the two authentication logic circuits 122 and 152 may verify that both the host 150 and module 102 are in possession of the private keys that mathematically correspond to their public keys, authenticating the connection between the devices.

In some embodiments, only intra-module authentication may be used. In some embodiments, after authentication between the host 150 and module logic circuit 120, the module logic circuit 120 may also authenticate itself with the memory devices 110. For example, responsive to authentication with the host authentication logic circuit 152, the module authentication logic circuit 122 may perform authentication with the authentication logic circuits 112 of the memory devices 110.

Responsive to authenticating the connection between the module logic chip 120 and memory devices 110 (and optionally also between the host 150 and module 102), the module 102 may enable, disable, or otherwise change the operation of one or more features of the memory module 102. The feature may be a feature of the memory devices 110. In some embodiments, the feature may be enabled on all of the memory devices 110. In some embodiments, the feature may be enabled on selected ones of the memory devices 110. In some embodiments, the feature may be automatically enabled after authentication. In some embodiments, the host 150 may send a command to enable the feature after authentication.

In some embodiments, the authentication between 112/122 and/or 122/152 may be performed any time the module 102 is powered on, reset, or otherwise re-initialized. In some embodiments, the authentication may be performed periodically. In some embodiments, the authentication may be performed on-demand, for example, the module 150 may issue a command to enable the feature, and responsive to that command the authentication may be performed. In some embodiments, any combination of the above authentication conditions may be used (e.g., when the device is powered on and also periodically thereafter).

In an example implementation, the feature may be an error correction pass-through feature. When the error correction pass-through is disabled, the memory devices 110 may perform error correction on the device, for example by generating error correction bits when data is written, and using those error correction bits to correct errors in the data when it is read and then provide the corrected data to the host 150. When the error correction pass-through is disabled, the error correction bits remain within the memory device. When error correction pass-through is enabled (e.g., after a successful authentication), the memory devices 110 still generate error correction information during write operations, but during read operations they provide the uncorrected data and the error correction information to the host 150. If the authentication is not successful, then the error correction pass-through mode cannot be enabled. Since extra bits are provided when the error correction pass-through is enabled compared to when it is disabled, the error correction bits may be provided by extending the burst length (e.g., number of serial bits) provided along the data terminals, or through other means such as by carving out one or more metadata bits with the error correction bits.

During an access operation, such as a read operation, data bits may be provided along one or more data terminals in parallel, and each terminal may be used to transmit a number of bits in series. The length of bits in the series may be referred to as the burst length. For example, in some modes, each channel may provide data along 2 data terminals with a burst length of 32, for a total of 64 bits. In some example embodiments, when the ECC pass through mode is disabled, then a first burst length may be used and when the ECC pass through mode is enabled (e.g., after authentication) then a second burst length may be used. For example, when the ECC pass through mode is disabled, then a burst length of 32 may be used, and when the ECC pass through mode is enabled, then a burst length of 36 may be used (e.g., for 64 bits of data and 8 bits of error correction). Other burst lengths and/or other numbers of data terminals may be used in other example embodiments.

In some embodiments, during an access operation such as a read operation metadata may be provided along with the data bits. The metadata may be information which is used to record information about the data. The metadata may be provided ‘in channel’ e.g., along the channel 114 or via a side band (e.g., through some other signal pathway such as the C/A bus). In some example embodiments, when the ECC pass through mode is disabled a first number of metadata bits may be provided along with the data. When the ECC pass through mode is enabled, some of those metadata bits may be carved out and replaced with error correction bits instead.

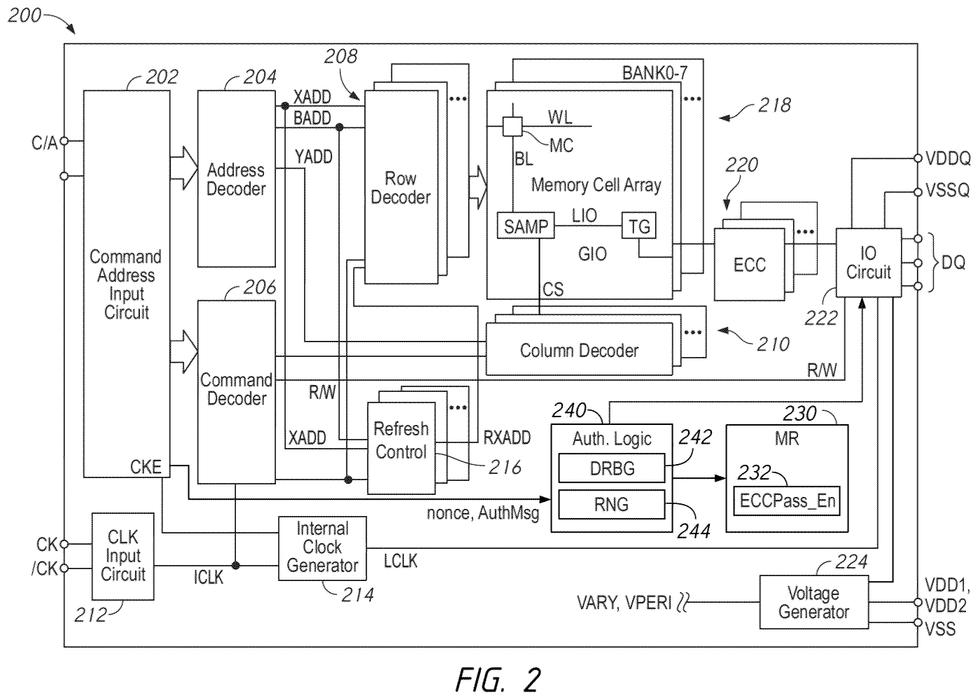

FIG. 2 is a block diagram of a semiconductor device according an embodiment of the disclosure. The semiconductor device 200 may be a semiconductor memory device, such as a DRAM device integrated on a single semiconductor chip. For example, the device 100 may implement one of the memory devices 110 of FIG. 1.

The semiconductor device 200 includes a memory array 218. The memory array 218 is shown as including a plurality of memory banks. In the embodiment of FIG. 2, the memory array 218 is shown as including eight memory banks BANK0-BANK7. More or fewer banks may be included in the memory array 218 of other embodiments.

Each memory bank includes a plurality of word lines WL, a plurality of bit lines BL, and a plurality of memory cells MC arranged at intersections of the plurality of word lines WL and the plurality of bit lines BL. The selection of the word line WL is performed by a row decoder 208 and the selection of the bit lines BL is performed by a column decoder 210. In the embodiment of FIG. 2, the row decoder 208 includes a respective row decoder for each memory bank and the column decoder 210 includes a respective column decoder for each memory bank.

The bit lines BL are coupled to a respective sense amplifier (SAMP). Read data from the bit line BL is amplified by the sense amplifier SAMP, and transferred to an ECC circuit 220 over local data lines (LIO), transfer gate (TG), and global data lines (GIO). Conversely, write data outputted from the ECC circuit 220 is transferred to the sense amplifier SAMP over the complementary main data lines GIO, the transfer gate TG, and the complementary local data lines LIO, and written in the memory cell MC coupled to the bit line BL.

The semiconductor device 200 may employ a plurality of external terminals, such as solder pads, that include command and address (C/A) terminals coupled to a command and address bus to receive commands and addresses, clock terminals to receive clocks CK and/CK, data terminals DQ coupled to a data bus to provide data, and power supply terminals to receive power supply potentials VDD, VSS, VDDQ, and VSSQ. The external terminals may couple directly to the controller (e.g., 150 of FIG. 1) and/or may couple to various buses/connectors of the module (e.g., 102 of FIG. 1).

The clock terminals are supplied with external clocks CK and/CK that are provided to an input circuit 212. The external clocks may be complementary. The input circuit 212 generates an internal clock ICLK based on the CK and/CK clocks. The ICLK clock is provided to the command decoder 206 and to an internal clock generator 214. The internal clock generator 214 provides various internal clocks LCLK based on the ICLK clock. The LCLK clocks may be used for timing operation of various internal circuits. The internal data clocks LCLK are provided to the input/output circuit 222 to time operation of circuits included in the input/output circuit 222, for example, to data receivers to time the receipt of write data. The input/output circuit 222 may include a number of interface connections, each of which may be couplable to one of the DQ pads (e.g., the solder pads which may act as external connections to the device 200).

The C/A terminals may be supplied with memory addresses. The memory addresses supplied to the C/A terminals are transferred, via a command/address input circuit 202, to an address decoder 204. The address decoder 204 receives the address and supplies a decoded row address XADD to the row decoder 208 and supplies a decoded column address YADD to the column decoder 210. The decoded row address XADD may be used to determine which row should be opened, which may cause the data along the bit lines to be read out along the bit lines. The column decoder 210 may provide a column select signal CS, which may be used to determine which sense amplifiers provide data to the LIO. The address decoder 204 may also supply a decoded bank address BADD, which may indicate the bank of the memory array 218 containing the decoded row address XADD and column address YADD.

The C/A terminals may be supplied with commands. Examples of commands include timing commands for controlling the timing of various operations, access commands for accessing the memory, such as read commands for performing read operations and write commands for performing write operations, refresh commands such as all-bank refresh and partial bank refresh, as well as other commands and operations. The access commands may be associated with one or more row address XADD, column address YADD, and bank address BADD to indicate the memory cell(s) to be accessed.

The commands may be provided as internal command signals to a command decoder 206 via the command/address input circuit 202. The command decoder 206 includes circuits to decode the internal command signals to generate various internal signals and commands for performing operations. For example, the command decoder 206 may provide signals which indicate if data is to be read, written, etc. The command decoder 206 may also provide one or more activations of a refresh signal REF responsive to a refresh command.

The device 200 may receive an access command which is a write command. When the write command is received, and a bank address, a row address and a column address are timely supplied with the write command, write data supplied to the data terminals DQ by the controller is provided along the data bus and written to memory cells in the memory array 218 corresponding to the row address and column address. The write command is received by the command decoder 206, which provides internal commands to perform the write operation. Write data is received by the IO circuit 222 and provided to optional ECC circuit 220, which generates error correction bits (e.g., parity bits) based on the write data. The row decoder 208 activates a word line based on the row address XADD, and the column decoder 210 couples bit lines selected by a column select signal CS (which is based on the column address YADD) to the LIO and GIO. The write data bits (and error correction bits) are written to the memory cells at the intersection of the active word line and the selected bit lines.

The device 200 may receive an access command which is a read command. When a read command is received, and a bank address, a row address and a column address are timely supplied with the read command, read data is read from memory cells in the memory array 218 corresponding to the row address and column address. The read command is received by the command decoder 206, which provides internal commands to activate the row indicated by the row address and couple the columns indicated by the column address through the LIO and GIO. The read data is provided through the IO circuit 222 to the DQ terminals and through those to the host device.

In some embodiments, the memory device may include error correction. When on-device error correction is used, the data and error correction bits are read from the array 218 to the ECC circuit 220 which detects and corrects errors in the data. For example, the ECC circuit 220 may use the error correction bits to locate and correct up to one bit of error in the read data. The corrected data may then be provided to the IO circuit 222. In some embodiments, the memory device 200 may include an ECC pass-through mode. When the ECC pass-through mode is enabled, the uncorrected data and error correction bits are provided to the IO circuit 222 and through that to the DQ terminals.

The device 200 includes a mode register 230. The mode register includes a number of storage elements, such as latch circuits, organized in registers. The registers store information such as settings of the memory. A controller (e.g., 150 of FIG. 1) may perform a mode register read operation to retrieve information from a specified register or a mode register write operation to write information to a specified register. Some registers may be read only to prevent the controller from modifying them. Some registers may be updated based on conditions or operations of the memory. For example a refresh rate multiplier may be set based on a measured temperature of the array 218. Some settings of the memory device may be protected, such that they can only be changed if the memory device 200 is in a properly authenticated connection with a module logic circuit and/or host device. For example, certain registers of the mode register 230 may be protected and may only be changed or updated from a default setting if the memory authentication logic circuit 240 indicates that the device 200 is in a properly authenticated configuration. Registers which enable/disable/modify the operation of sensitive features of the memory device 200 may be protected.

The memory device 200 includes a memory authentication logic circuit 240 (e.g., 112 of FIG. 1). The memory authentication logic circuit 240 unlocks protected registers of the mode register 230 when the memory authentication logic circuit 240 determines that the device 200 is in an authenticated configuration (e.g., coupled to an authenticated module logic chip). For example, the memory authentication logic circuit 240 may exchange authentication messages AuthMsg with the module logic circuit in order to authenticate the connection between the device 200 and the module logic chip. Once the memory authentication logic circuit 240 confirms the authentication, it may unlock the protected register(s) of the mode register 230. In some embodiments, instead of, or in addition to, controlling enablement/disablement of features through the mode register 230, the authentication logic circuit 240 may also control enablement/disablement in other ways. For example, the authentication logic circuit 240 may interact with the input/output circuit 222 to enable/disable access to certain portions of the array 218.

In an example implementation, the authentication logic circuit 240 may include a secret, such as a secret key. The authentication messages AuthMsg may determine if the secret matches a secret stored on the module authentication logic. For example, the authentication message AuthMsg may be encrypted and decrypted based on the shared secret. If the authentication logic circuit 240 decrypts the authentication message AuthMsg it may indicate that the secret on the memory authentication logic 240 matches a secret on the module authentication logic circuit.

The memory authentication logic circuit 240 receives a random number nonce (or number used once) from outside the memory device 200. For example, the random number nonce may be generated by an RNG circuit of the module logic chip such as 124 of FIG. 1. The random number may be used by the memory authentication logic circuit 240 as part of the authentication operation. The memory authentication logic circuit 240 also includes a random number generator circuit 244 which generates a random number. The memory device 200 may provide the random number generated by the random number generator circuit 244. The memory authentication logic circuit 240 may store a copy of the random number generated by the random number generator circuit 244 and combine it with the received random number nonce to form a shared random number. In some embodiments, the random number generated by the random number generator circuit 244 may have fewer bits than the received random number nonce.

In some embodiments, multiple random numbers and authentication messages may be sent and received as part of an authentication operation and/or in preparation for an authentication operation. For example, a first received random number may be used along with the generated random number to generate a session key for an authentication operation, and a second received random number may be used for authentication operations based on that session key. In some embodiments, the memory authentication logic circuit 240 may include a pseudo-random number generator, such as a deterministic random bit generator (DRBG) circuit 242, which generates pseudo-random numbers as part of the authentication operation. For example, the DRBG circuit 242 may generate pseudo-random numbers which have many more bits than the random numbers generated by the random number generator circuit 244.

As an example of a protected feature, the mode register 230 may include an ECC pass through enable register 232 ECCPass_En. The ECC pass through enable register 232 may default to a disabled state which disables an ECC pass-through mode (e.g., causing the ECC circuit 220 to perform error correction on the device 200). When the memory authentication logic circuit 240 indicates that the device is in an authenticated configuration, the state of the ECC pass through enable register 232 may be changed (e.g., to enable an ECC pass through mode). In some embodiments, the state of the protected register, such as 232) may be automatically changed when the module authentication logic circuit 240 indicates an authenticated configuration. In some embodiments, the authentication may allow a mode register write operation to change a state of the protected register, such as 232.

Regardless of the state of the ECC pass through mode, during write operations, data is received and the ECC circuit may generate error correction bits based on that data. The data and error correction bits are written to the memory array 218. In a read operation, when the ECC pass-through mode is disabled, the ECC circuit 220 receives the data and error correction bits and uses the error correction bits to detect/correct errors in the data. For example, the ECC circuit may be able to locate and correct up to 1 bit of error (e.g., single error correction or SEC) in the data. The corrected data is provided to the IO circuit and through that to the host. In a read operation, when the ECC pass through mode is enabled, the ECC circuit 220 may be disabled, and the data and error correction bits may be provided to the IO circuit 222 and the IO circuit may provide both the uncorrected data and the error correction bits to the host. In some embodiments, the extra error correction bits may be provided via burst length extension, metadata carve out, or combinations thereof.

The device 200 includes refresh control circuits 216 each associated with a bank of the memory array 218. Each refresh control circuit 216 may determine when to perform a refresh operation on the associated bank. Responsive to the refresh command REF, the refresh control circuit 216 performs one or more refresh operations. As part of a refresh operation, the refresh control circuit 216 provides a refresh address RXADD (along with one or more refresh signals, not shown in FIG. 1). The row decoder 208 performs a refresh operation on one or more word lines associated with RXADD. The refresh control circuit 216 may perform multiple types of refresh operation, which may determine how the address RXADD is generated, as well as other details such as how many word lines are associated with the address RXADD.

The power supply terminals are supplied with power supply potentials VDD and VSS. The power supply potentials VDD and VSS are supplied to an internal voltage generator circuit 224. The internal voltage generator circuit 224 generates various internal potentials VARY, and the like based on the power supply potentials VDD and VSS supplied to the power supply terminals.

The power supply terminals are also supplied with power supply potentials VDDQ and VSSQ. The power supply potentials VDDQ and VSSQ are supplied to the input/output circuit 222. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 122 so that power supply noise generated by the input/output circuit 122 does not propagate to the other circuit blocks.

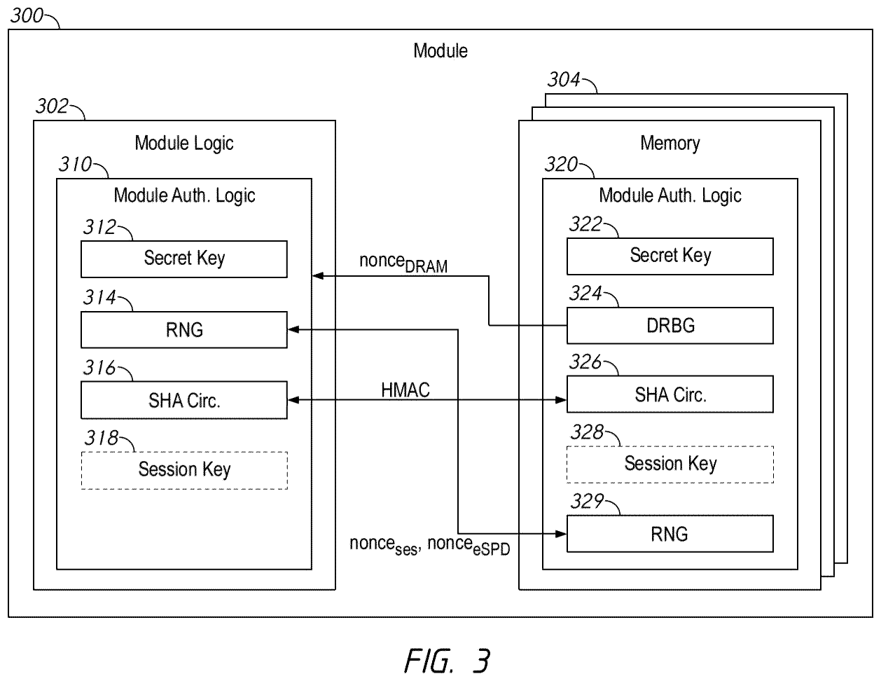

FIG. 3 is a block diagram of module authentication logic according to some embodiments of the present disclosure. FIG. 3 shows a module 300 which may, in some embodiments implement the module 102 of FIG. 1. The module 300 includes a module logic chip 302 (e.g., 120 of FIG. 1) with a module authentication logic circuit 310 (e.g., 122 of FIG. 1) and memory devices 304 (e.g., 110 of FIGS. 1 and/or 200 of FIG. 2) with memory authentication logic circuits 320 (e.g., 112 of FIGS. 1 and/or 240 of FIG. 2). For the sake of brevity, only a single memory authentication logic circuit 320 is shown in detail.

The module authentication logic circuit 310 includes a stored copy of a secret key 312, an RNG circuit 314, a cryptographic key derivation circuit 316, and a stored session key 318. The memory authentication logic circuit 320 includes a stored copy of the secret key 322, a pseudo-random number generator such as DRBG circuit 324 (e.g., 242 of FIG. 2), an RNG circuit 329 (e.g., 244 of FIG. 2), an cryptographic key derivation circuit 326 and a stored copy of the session key 328. The session keys 318 and 328 may be stored temporarily and used for a single authentication operation or session between the module logic chip 302 and memory 304. On a subsequent authentication operation, a different session key may be generated and saved as the session key copies 318 and 328, as described in more detail herein. While not shown in FIG. 3, both the module authentication logic circuit 310 and memory authentication logic circuit 320 may have additional respective storage such as latch circuits, for storing one or more other values such as random numbers, payloads, or other values.

The two copies of the secret key 312 and 322 match each other. The copies of the secret key 312 and 322 may be loaded in non-volatile storage of the module logic chip 302 and memory device 304 respectively. For example, the module copy of the secret key 312 may be stored in a fuse array of the module logic chip 302, and the memory copy of the secret key 322 may be stored in a fuse array of the memory 304. The copies of the secret key 312 and 322 may be loaded onto the module logic chip 302 and memory 304 in a trusted facility. For example, when the module 300 is assembled in a trusted factory, the secret key may be generated and copies thereof may be loaded onto the module.

In some embodiments, all of the memory devices 304 may have a copy of the same secret key. Accordingly, the module logic circuit 302 may store a matching copy of that same key. In some embodiments, there may be different keys for one or more of the memory devices 304 and the module logic chip 302 may store a copy of each of those keys. For example, the memory devices 304 may be split into subsets and each subset may have copies of a same key, but which are different from the secret key on the other subsets. In some embodiments, each memory device 304 may store a copy of a different secret key, and the module logic chip 302 may store a copy of a secret key for each of the memory devices 304. For the sake of brevity, authentication will generally be discussed with respect to a single memory device 304, and generally only a single copy of the secret key will be discussed with respect to the module logic chip 302.

The module authentication logic circuit 310 includes a RNG circuit 314 which may be used to generate random numbers. The RNG circuit 314 may be non-deterministic. The memory 304 includes an RNG circuit 329. The memory RNG circuit 329 may be non-deterministic. In some embodiments, the memory RNG 329 may generate random numbers of shorter length than the module RNG circuit 314. The RNG circuits 314 and 329 may be used to generate entropy used to increase the uniqueness of the encrypted information sent back and forth between the module logic chip 302 and memory 304. This, in turn, may make it more difficult to replay the operations between logic chip and memory. The memory 304 also includes a pseudo-random number generator circuit or DRBG circuit 324. The DRBG circuit 324 may be deterministic. The DRBG circuit 324 may accept inputs, such as the random numbers from the RNG circuit 314 and 329 and use those as seeds to generate a pseudo-random number.

The module authentication logic circuit 310 also includes an cryptographic key derivation circuit 316. The cryptographic key derivation circuit 316 may be implemented with a secure hash algorithm circuit, such as an SHA256 circuit in some example embodiments. The SHA circuit 316 accepts one or more inputs and uses logic gates to perform a hash function and generate an output. The memory authentication logic circuit 320 also includes a cryptographic key derivation circuit 326. In some embodiments, the cryptographic key derivation circuit 326 may be a SHA circuit 326, which may match the SHA circuit 316 in the module logic circuit. For example, the two SHA circuits 316 and 326 may implement matching hash functions. In this manner, if given the same inputs, the two SHA circuits 316 and 326 may generate the same outputs. The two cryptographic key derivation circuits 316 and 326 may generally be referred to as SHA circuits, although other key derivation functions and circuits are possible in other example implementations.

During an example authentication operation, the module logic chip 302 and memory 304 may first generate their respective copies of the shared session key 318 and 328. The module RNG circuit 314 generates a first random number nonce_{SES_eSPD} and provides it to both the SHA circuit 316 in the module authentication logic circuit 310 and the SHA circuit 326 in the memory authentication logic circuit 320. The memory RNG circuit 329 generates a second random number nonce_{SES_DRAM} and provides it to both the SHA circuit 326 in the memory 320 and the SHA circuit 316 in the module logic chip 302. The two random numbers nonce_{SES_eSPD} and nonce_{SES_DRAM} may generally be used together, and so may be treated together as a shared random number nonce_{SES}. The module SHA circuit 316 uses the shared random number nonceₛₑₛ and the module's copy of the secret key 312 to generate a value of the session key 318. The memory SHA circuit 326 uses the shared random number nonceₛₑₛ and the memory's copy of the secret key 322 to generate a value of the session key 328. Since the inputs should match (e.g., since the copies of the secret keys 312 and 322 should match) the two session keys 318 and 328 should also match.

Once the two session key copies 318 and 328 are generated, the session keys may be used to generate authentication messages, such as hashed message authentication codes (HMACs). Along with the session key copies 318 and 328, the RNG circuit 314 may be used to generate a third random number nonce_{eSPD}, which in turn may be used by the DRBG circuit 324 to generate a pseudo-random number nonce_{DRAM}. The third random number and pseudo-random number may be used to generate HMACs as described in more detail herein.

The module may provide the third random number nonce_{eSPD} as a challenge to the memory 304 and the memory SHA circuit 326 may generate an HMAC based on the third random number (and in some embodiments also on the pseudo-random number) and the memory's copy of the session key 328 and provide the HMAC as a response to the module authentication logic circuit 302. If the module SHA circuit 316 can decrypt the HMAC based off the module's copy of the session key 318, then the memory may be authenticated. The memory 304 provides the pseudo-random number (in some embodiments along with the second random number) as a challenge to the module logic chip 302. The module SHA circuit 316 generates a second HMAC based on the pseudo-random number nonce_{DRAM} and the module's copy of the session key 318 and provides it as a response to the memory device 304. The memory SHA circuit 326 receives HMAC from the module logic chip 302 and decrypts it based on the pseudo-random number. If the second HMAC is decrypted, the memory authentication logic 320 may have authenticated the module logic chip 302.

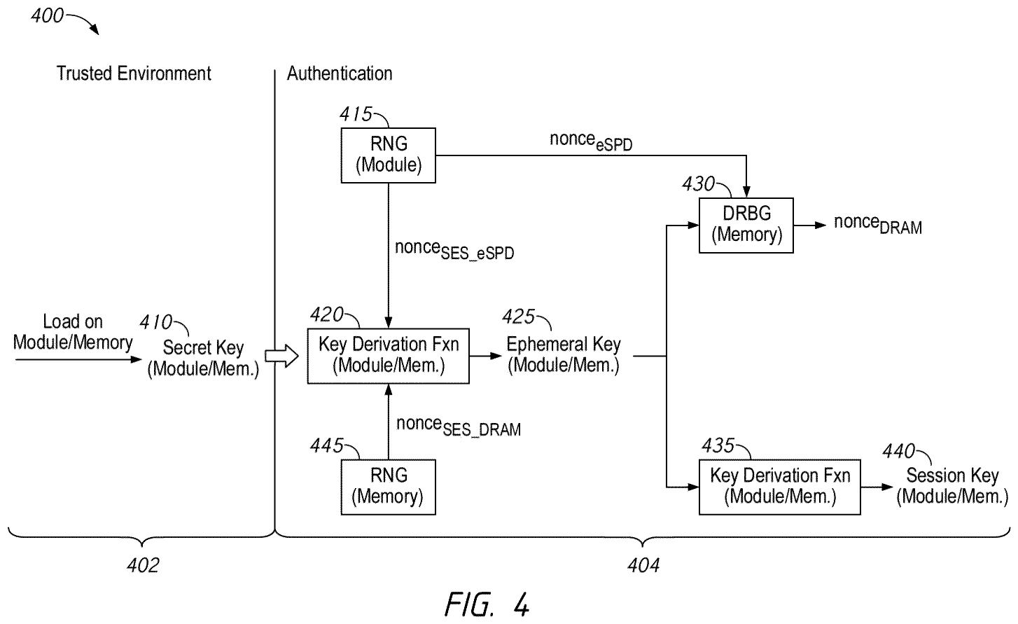

FIG. 4 is a flow chart of a process of generating various values used in authentication operations according to some embodiments of the present disclosure. The method 400 may, in some embodiments, be implemented by one or more of the apparatuses and/or systems described herein. For example, the method 400 may be performed by the memory module 102 of FIG. 1, by the memory device 200 of FIG. 2, and/or the module 300 of FIG. 3. The method 400 may generally be described with respect to authentication between a module logic chip and a single memory, however, the method 400 may be repeated for authentication with other memory devices of the module (either with a same or different copy of the secret key).

The method 400 is a schematic view showing the relationship between various values generated and/or used as part of authentication operations, such as the copies of the secret key (e.g., 312 and 322 of FIG. 3) and the copies of the session key (e.g., 318 and 328 of FIG. 3) as well as the random numbers nonce_{ses_eSPD}, nonce_{SES_DRAM}, and nonce_{eSPD} and pseudo-random number nonce_{DRAM}. The method 400 shows physical elements, such as circuits, used to generate values in boxes, and shows the values themselves, such as the keys and random numbers without boxes.

The method 400 includes a first portion 402, which is performed in a trusted environment, such as a secure facility. For example, the first portion 402 may be performed in a factory of a trusted manufacturer authorized to assemble the memory chips and/or module logic chip(s) onto the module. The method 400 includes generating a matching pair of copies of a secret key 410. The method 400 includes loading a first copy of the secret key onto the module logic chip and a second copy of the secret key onto the memory. For example, the keys may be loaded into non-volatile storage elements such as fuses or anti-fuses of their respective devices. The method 400 may include loading the copies of the secret keys into protected storage such that the secret keys cannot normally be accessed be devices other than the one that stores the copy of the key.

The first portion 402 may occur as part of an initialization, for example when the module is assembled, and not repeated for each authentication operation. The method 400 includes a second portion 404, which is repeated for each authentication operation.

The method 400 include generating a first session random number nonce_{SES_eSPD} with an RNG circuit 415 (e.g., 124 of FIGS. 1 and/or 314 of FIG. 3) of the module logic chip. The method 400 may include generating the first session random number with a non-deterministic process. The method 400 may include generating the first session random number on the module, and then providing the first session random number to the memory. The method 400 also includes generating a second session random number nonceSES_eSPD with an RNG circuit 445 (e.g. 244 of FIGS. 2 and/or 329 of FIG. 3) of the memory device. The method 400 may include generating the second session random number with a non-deterministic process. The method 400 may include generating the second session random number on the memory, and then providing the second session random number to the module.

The method 400 includes generating copies of an ephemeral key 425 using key derivation functions 420 on both the module and the memory. The ephemeral key 425 may be a temporary step on the way to generating the session key copies 440. The key derivation function 420 may be a sequence of logic gates used to generate a key based on one or more inputs. The key derivation function may be implemented separately on both the module logic chip and on the memory device. For example, the key derivation function 420 may be implemented by the SHA circuit 316 on the module authentication logic circuit 310 and the SHA circuit 326 of the memory authentication logic circuit 320. The two implementations may each perform the same key derivation function 420 so that given the same inputs, the outputs may match on each of the module logic chip and the memory. The key derivation function 420 generates the ephemeral key 425 based on the secret key and the first session random number nonce_{SES_eSPD} and the second session random number nonce_{SES_DRAM}. In some embodiments, additional inputs may be used, such as a text string specific to the ephemeral key. Since the inputs match (e.g., both the module and memory have matching copies of the secret key 410 and the same two session random numbers) both the memory and the module should have matching copies of the ephemeral key 425.

The copies of the ephemeral key 425 are used to generate a pseudo-random number nonce_{DRAM} and the session key copies 440. The method 400 includes generating the session key copies 440 based on the ephemeral key copies 425 using key derivation functions on both the module and the memory. In some embodiments, the key derivation function 435 may be the same key derivation function 420 as was used to generate the ephemeral key copies 425. Both the module logic chip and the memory device include circuits which implement the key derivation function, for example the SHA circuits 316 and 326 of FIG. 3. In some embodiments, the key derivation function 435 may receive an additional input, not shown, such as a text string, which may help differentiate it from the operation of the key derivation function 420 when used to generate the ephemeral key copies 425. Since both the module logic chip and the memory have matching copies of the ephemeral key 425, and since the same key derivation function 435 is implemented on each, the copy of the session key 440 generated on both the module logic chip and the memory should match each other. The method 400 may include storing the session key copies on both the module logic chip and the memory.

The method 400 also includes generating a second random number nonce_{eSPD} with the random number generator circuit 415 of the module and providing the second random number nonce_{eSPD} to the memory device. The method 400 includes generating a pseudo-random number nonce_{DRAM} with a pseudo-random number generator 430 of the memory based on the second random number nonce_{eSPD} and the ephemeral key copy 425 on the memory. The pseudo-random number generator 430 may use the second random number nonce_{eSPD} and the ephemeral key 425 as inputs to generate the pseudo-random number nonce_{DRAM}. In some embodiments, an additional input, not shown, such as a text string may be used.

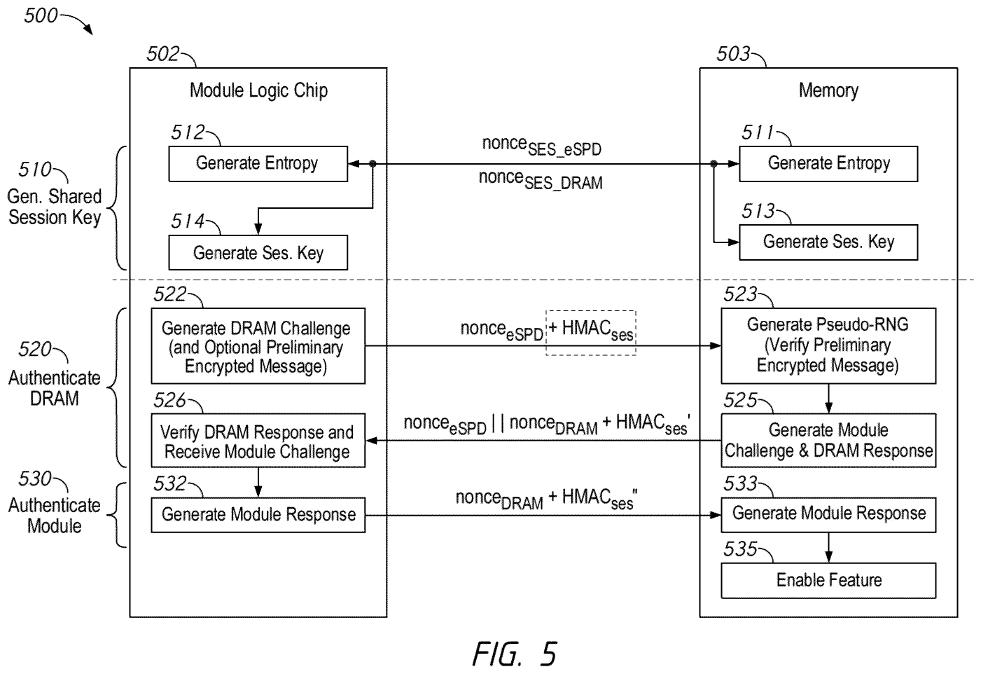

FIG. 5 is a flow chart of a method of an intra-module authentication operation according to some embodiments of the present disclosure. The method 500 may, in some embodiments be implemented by one or more of the apparatuses and/or systems described herein. For example, the method 500 may be implemented by the module 102 of FIGS. 1 and/or 300 of FIG. 3. The method 500 includes a box 502 which represents steps performed on a module logic chip such as 120 of FIGS. 1 and/or 302 of FIG. 3 and a box 503 which represents steps performed on a memory device such as 110 of FIG. 1, 200 of FIG. 2, and/or 304 of FIG. 3. The method 500 may use various values, which may be generated using a method such as the method 400 of FIG. 4.

The method 500 may represent steps which are performed as part of an authentication operation between a module logic chip 502 and a memory device 503. The method 500 may be performed at connection, on power-up/reset, periodically, on-demand, or combinations thereof. In some embodiments, the method 500 may be performed responsive to successful authentication between the module logic chip 502 and a host (e.g., 150 of FIG. 1). For example, the host and module logic chip 502 may authenticate each other based on asymmetric cryptography (e.g., public-key encryption), and once authenticated, the module logic chip 502 may begin performing the method 500 to authenticate with the memory. FIG. 5 will generally be described with respect to authentication with a single memory device. However, the method 500 may be repeated for multiple memory devices of the module. In some embodiments, certain steps or values may be shared between multiple of the memory devices. For example, if multiple memory devices share copies of a same secret key, then the module chip may only need to generate a single copy of the session key, and may not need to repeat that step for each memory device.

The method 500 includes step 510 which describes generating copies of a shared session key based off a first session random number generated by the module logic chip 502, a second session random number generated by the memory device 503, and a copy of the secret key stored on each of the module logic chip 502 and a copy of the secret key stored on the memory device 504. The method 500 includes step 520, which describes authenticating the memory device with the module logic chip and step 530, which describes authenticating the module logic chip with the memory device. The authentication may be based on the device's ability to successfully encrypt and decrypt messages with their respective copies of the session key.

Step 510 may generally begin with boxes 511 and 512, which describes generating entropy. The entropy may be used to help ensure uniqueness in the authentication process. Generating the entropy may be implemented by generating a random number with a random number generator circuit. Box 512 describes generating entropy on the module logic chip 502, for example by generating a first session random number nonce_{SES_eSPD} with a module random number generator circuit (e.g., 124 of FIG. 1,314 of FIG. 3, and/or 415 of FIG. 4). Box 511 describes generating entropy on the memory device 503, for example by generating a second session random number nonceSES_DRAM with a memory random number generator circuit (e.g., 244 of FIG. 2, 329 of FIG. 3, and/or 445 of FIG. 4).

The method 500 may include generating the session random numbers with a non-deterministic process. The entropy will generally be referred to as a random number, however other forms of entropy may be used in other example embodiments. Box 512 describes generating the first session random number nonceSES_eSPD, storing it on the module logic circuit 502 and providing the first session random number to the memory device 503, for example by writing the first session random number to a mode register of the memory device. Box 511 describes generating the second session random number nonceSES_DRAM and storing it on the memory device 503 for example in a mode register. The method 500 may include the module logic chip 502 reading the second session random number nonceSES_DRAM from the memory device 503, for example from a mode register of the memory. The two session random numbers are used together by circuits which implement a key derivation function (e.g., 420 of FIG. 4) on both the module logic circuit 502 and the memory device 504, such as the SHA circuits 316 and 326 of FIG. 3, respectively.

Boxes 511 and 512 are followed by boxes 513 and 514, which describe generating a copy of the session key based on the session random numbers nonce_{ses_eSPD}, nonce_{SES_DRAM} and a stored copy of the secret key on the module logic chip 502 and on the memory respectively. The process of generating the session key copy may be similar on both devices. The box 513 describes generating the session key (e.g., with a circuit that implements a key derivation function) using the session random numbers and the memory's copy of the secret key. The box 514 describes generating the session key (e.g., with a circuit of the module authentication logic circuit which implements the key derivation function) using the session random numbers and the module logic circuit's copy of the secret key. In some embodiments, the boxes 513 and 514 may include generating an ephemeral key (e.g., 425 of FIG. 4) as part of generating the session key. Assuming no errors, since the key derivation functions and the inputs should match on both the module logic chip 502 and memory device 503, the two copies of the session key should also match. In this sense the session key may be shared between the two devices, although each device may individually manage its own copy of the session key and neither copy may leave its respective device.

Step 520 describes authenticating the DRAM with the module logic chip. Step 520 may generally begin with box 522, which describes generating a challenge to the memory 504 with the module logic chip 502. The challenge may take the form of a random number, such as a third random number nonce_{eSPD}. Box 522 may include generating the third random number with the RNG circuit. Box 522 may include providing the third random number to the memory device 503.

In some embodiments, the method 500 may include the optional step of generating a preliminary encrypted message HMACₛₑₛ as part of box 522. The preliminary encrypted message may include a payload (e.g., a message) which is encrypted based on the module logic chip's 502 copy of the session key and the third random number nonce_{eSPD}. The method 500 may include encrypting the message based on a hash function, such as the SHA circuit (e.g., 316 of FIG. 3). The method 500 may include providing the preliminary encrypted message to the memory 503.

Box 522 may generally be followed by box 523, which describes generating a pseudo-random number nonce_{DRAM} based on the third random number nonce_{eSPD}. The pseudo-random number may be additionally based on the memory's copy of the session key or on the memory's copy of the ephemeral key. Box 523 may include generating the pseudo-random number via a deterministic process, such as with a DRBG circuit (e.g., 242 of FIGS. 2 and/or 324 of FIG. 3).

In some embodiments, box 523 may additionally include verifying the preliminary encrypted message. Box 523 may include decrypting the preliminary encrypted message HMACses based on the received third random number nonce_{eSPD}) and the memory's copy of the session key. Since the memory's copy of the session key should match the module logic chip's copy of the session key used to encrypt the message, the memory 503 should be able to decrypt the preliminary encrypted message. The memory 503 may verify the authenticity of the received HMAC by computing its own HMAC with the received nonceSPD and its version of the session key, and then comparing to confirm that the received HMAC matches its calculated HMAC.

Box 523 may generally be followed by box 525, which describes generating a memory response with the memory device 503 responsive to the challenge provided by the module logic chip (e.g., the third random number). The response may take the form of a first encrypted message HMACₛₑₛ′. Box 525 may include encrypting a payload (e.g., a message) into the second encrypted message. The method 500 may include encrypting the payload by hashing the payload with a hash circuit such as the SHA circuit 326 of FIG. 3. Box 525 may also include generating a module challenge with the memory device 503. The module challenge may take the form of a combined value which combines both the third random number nonce_{eSPD} and the pseudo-random number nonce_{DRAM}. For example, the method 500 may include combining the second random number nonce_{eSPD} and the pseudo-random number nonce_{DRAM} into the combined value nonce_{eSPD}∥nonce_{DRAM}. In some embodiments, the combining may take the form of concatenating the two values. Other forms of combination may be used in other embodiments. Box 525 may include generating the first encrypted message HMACₛₑₛ′ by encrypting the payload based on the memory's copy of the session key and the combined value. Box 525 may include providing the memory's module challenge (e.g., the combined value) and the memory's response (e.g., the first encrypted message) to the module logic circuit.

Box 525 may generally be followed by box 526, which describes receiving the module challenge (e.g., the combined value) from the memory and verifying the memory's response. The verifying may include decrypting the first encrypted message HMACₛₑₛ′. For example, the module logic chip 502 may verify the authenticity of the received HMACₛₑₛ′ by computing its own HMACₛₑₛ with the received combined number (nonce_{eSPD}) and nonce_{DRAM}) and its version of the session key, and then comparing to confirm that the received HMACₛₑₛ′ matches its calculated HMACₛₑₛ′. The verification may also include extracting the third random number nonce_{eSPD} from the combined number and confirming that the extracted second random number matches a stored copy of the second random number. If the verification is successful (e.g., the message decrypts successfully) then the module logic chip may consider the memory authenticated, as it holds a session key (and thus a secret key) which matches the module logic chip's. If the verification is successful, then the method 500 may proceed to step 530.

Step 530 describes authenticating the module with the memory device. The authentication may be performed responsive to the challenge (e.g., the combined number) received from the memory during step 520. Step 530 may generally begin with box 532, which describes generating a module response to the memory's module challenge. The module response may take the form of a second encrypted message HMACₛₑₛ″. Box 532 includes encrypting a payload (e.g., a message) based on the copy of the session key stored on the module logic chip 502 and the pseudo-random number nonce_{DRAM}. For example, the method may include encrypting the payload by hashing the payload with a hash circuit (e.g., 316 of FIG. 3). Box 532 may include providing the second encrypted message HMACₛₑₛ″ and the pseudo-random number nonceDRAM used (in part) to encrypt it from the module logic 502 to the memory 503.

Box 532 may generally be followed by box 533, which describes verifying the module response received from the module logic chip 502 at the memory 503. Box 533 may include decrypting the second encrypted message HMACₛₑₛ″ at the memory device 503 using the memory's copy of the session key and the pseudo-random number nonce_{DRAM}. For example the decrypting may include reversing the hashing applied to the message with a hash circuit such as 326 of FIG. 3. The verification may include comparing a decrypted content of the message to an expected content to ensure a match. In some embodiments, the verification may also include determining if the received pseudo-random number matches a stored copy of the pseudo-random number generated in box 523. If the verification is successfully completed, then the memory may consider the module to be authenticated.

If the authentication is successful, then box 533 may be followed by box 535 which describes enabling a feature. For example the feature may be a feature of the memory device 503 such as ECC pass-through. In some embodiments, the enabling may be automatic and the box 535 may include updating a feature enable setting in a mode register. In some embodiments, box 535 may include enabling modification of a protected register, and then the enabling may happen when a mode register write operation is performed on the register.

By performing the authentication of the module only if the authentication of the memory completed successfully, and by performing the enablement of the feature only if the authentication of the module completed successfully, the feature may only be enabled if both the module and memory authenticate each other.

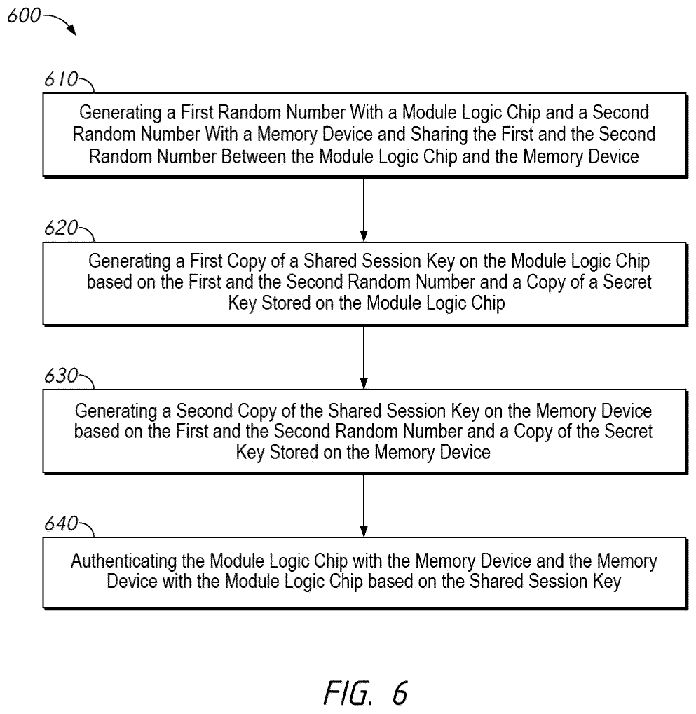

FIG. 6 is a flow chart of a method of intra-module authentication according to some embodiments of the present disclosure. The method 600 may, in some embodiments, be implemented on one or more of the apparatuses and/or systems described herein. For example, the method 600 may be implemented by the memory module 102 of FIGS. 1 and/or 300 of FIG. 3. The method 600 may include generating values in a manner similar to the method 400 of FIG. 4 and/or using those values in a manner similar to the method 500 of FIG. 5. For the sake of brevity, certain operations already described with respect to the methods 400 and 500 will not be repeated again with respect to the method 600 of FIG. 6.

The method 600 may generally begin with box 610, which describes generating a first random number with a module logic chip and a second random number with a memory device and sharing the first and the second random number between the module logic chip and the memory device. The module logic chip (e.g., 120 of FIG. 1, 302 of FIG. 3, and/or 502 of FIG. 5) and memory device (e.g., 110 of FIG. 1, 200 of FIG. 2, 304 of FIGS. 3, and/or 503 of FIG. 5) may be packaged together onto a memory module (e.g., 102 of FIGS. 1 and/or 300 of FIG. 3). The method 600 may include generating the first random number (e.g., nonce_{SES_eSPD}) with an RNG circuit (e.g., 124 of FIGS. 1 and/or 314 of FIG. 3) of the module logic circuit and the second random number (e.g., nonce_{SES_DRAM}) with an RNG circuit (e.g., 244 of FIGS. 2 and/or 329 of FIG. 3) of the memory device. The method 600 may include generating the random number via a non-deterministic process.

Box 610 may generally be followed by box 620, which describes generating a first copy of a shared session key on the module logic chip based on the first and the second random number and a copy of a secret key stored on the module logic chip. For example, the method may include providing the copy of the secret key and the first and the second random number to a circuit on the module logic chip which implements a key derivation function such as an SHA circuit (e.g., 316). In some embodiments, the method 600 may include generating an ephemeral key (e.g., 425 of FIG. 4) and then using the ephemeral key to generate the copy of the session key.

Box 620 may generally be followed by box 630, which describes generating a second copy of the shared session key on the memory device based on the first and the second random number and a copy of the secret key stored on the memory device. For example, the method 600 may include providing the copy of the secret key and the first and the second random number to a circuit on the memory device which implements a key derivation function such as an SHA circuit (e.g., 326). In some embodiments, the method 600 may include generating an ephemeral key (e.g., 425 of FIG. 4) and then using the ephemeral key to generate the copy of the session key.

Although shown as sequential in FIG. 6, boxes 620 and 630 may happen more or less simultaneously to each other. Boxes 610-630 may, in some embodiments, implement the step 510 of FIG. 5.

Boxes 620 and 630 may generally be followed by box 640, which describes authenticating the module logic chip with the memory device and the memory device with the module logic chip based on the shared session key. For example, authenticating the memory with the module logic chip may be implemented by step 520 of FIG. 5 and authenticating the module logic chip with the memory device may be implemented by step 530 of FIG. 5.

Box 640 may include challenging the memory with the module logic chip and responding from the memory to the module logic chip, and challenging the module logic chip with the memory and responding from the module logic chip to the memory device. In some embodiments, the memory may respond and challenge the module logic chip as part of the same action. For example, the method 600 may include generating a third random number with the module logic chip and providing the third random number as a first challenge, generating a pseudo-random number with the memory device based on the third random number, generating a response with the memory device by encrypting a payload based on the second copy of the shared session key, the third random number, and the pseudo-random number and providing the encrypted payload, the third random number, and the pseudo-random number as a first response and a second challenge, verifying the response with the module logic circuit by decrypting the payload based on the first copy of the shared session key, the third random number, and the pseudo-random number, responding to the pseudo-random number by encrypting a second payload with the module logic chip based on the first copy of he shared session key and the pseudo-random number and providing the encrypted second payload and the pseudo-random number as a second response, and verifying the second challenge by decrypting the encrypted second payload based on the second copy of the shares session key and the pseudo-random number. In some embodiments, the method 600 may include generating a preliminary encrypted message by encrypting a preliminary payload with the module logic circuit based on the third random number and the first copy of the shared session key and decrypting the preliminary encrypted message with the memory device based on the third random number and the second copy of the shared session key.

In some embodiments, the method 600 may include enabling a feature of the memory device, the module logic circuit, or combinations thereof responsive to authenticating the module logic chip with the memory device and the memory device with the module logic chip. For example, the method 600 may include enabling an ECC pass-through feature of the memory device. In some embodiments, the method 600 may be at power on, reset, on-demand, or combinations thereof.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a module logic chip comprising:
a module authentication logic circuit; and
a random number generator circuit; and
a plurality of memory devices, each comprising:
a memory authentication logic circuit which includes a random number generator circuit,
wherein the random number generator circuit of the module logic chip is configured to generate a first random number which is provided to at least one of the plurality of memory authentication logic circuits, wherein the random number generator circuit of the at least one of the plurality of memory authentication logic circuits is configured to generate a second random number which is provided to the module logic chip, and wherein the module authentication logic circuit and the at least one of the plurality of memory authentication logic circuits are configured to authenticate each other based, at least in part, on copies of a shared session key generated from the first and the second random numbers.

2. The apparatus of claim 1, wherein the module authentication logic circuit is configured to store a first copy of a secret key, and the memory authentication logic circuit is configured to store a second copy of the secret key and wherein the copies of the shared session key are generated based, in part, on the first copy and the second copy of the secret key.

3. The apparatus of claim 2, wherein the module logic chip includes a cryptographic key derivation circuit configured to generate the copy of the shared session key on the module logic chip based on the first and the second random numbers, and
wherein the plurality of memory devices each include a cryptographic key derivation circuit configured to generate the copy of the shared session key on the respective one of the plurality of memory devices based on the first and the second random numbers.

4. The apparatus of claim 3, wherein the cryptographic key derivation circuits are secure hash algorithm (SHA) circuits.

5. The apparatus of claim 2, wherein each of the plurality of memory devices is configured to store a different secret key, and the module authentication logic circuit is configured to store a plurality of secret keys, each matching the secret key on only one of the plurality of memory devices.

6. The apparatus of claim 2, wherein each of the plurality of memory devices is configured to store a copy of the same secret key.

7. The apparatus of claim 1, wherein each of the plurality of memory devices include a dynamic random bit generator (DRBG) circuit configured to generate a pseudo-random number, wherein the module authentication logic circuit and the at least one of the plurality of memory authentication logic circuits are configured to authenticate each other based, in part, on the pseudo-random number.

8. The apparatus of claim 7, wherein the random number generator circuit on the module logic chip and the random number generator circuits on the memory authentication logic circuits are non-deterministic and the DRBG circuits are deterministic.

9. The apparatus of claim 1, wherein the at least one of the plurality of memory authentication logic circuits is configured to enable a feature if the authentication is successful.

10. The apparatus of claim 9, wherein the feature is an ECC pass-through mode, and wherein the ECC pass-through mode cannot be enabled if the authentication is not successfully performed.

11. A method comprising:
generating a first random number with a module logic chip and a second random number with a memory device and sharing the first and the second random numbers between the module logic chip and the memory device, wherein the module logic chip and the memory device are both packaged on a module;
generating a first copy of a shared session key on the module logic chip based on the first and the second random numbers and a copy of a secret key stored on the module logic chip;
generating a second copy of the shared session key on the memory device based on the first and the second random numbers and a copy of the secret key stored on the memory device; and
authenticating the module logic chip with the memory device and the memory device with the module logic chip based on the shared session key.

12. The method of claim 11, further comprising generating the first copy and the second copy of the shared session key at power on, reset, on-demand, or combinations thereof.

13. The method of claim 11, wherein authenticating the memory device with the module logic chip and the memory device with the module logic chip comprises:
generating a third random number with the module logic chip and providing the third random number as a first challenge;
generating a pseudo-random number with the memory device based on the third random number;
generating a response with the memory device by encrypting a payload based on the second copy of the shared session key, the third random number, and the pseudo-random number and providing the encrypted payload, the third random number, and the pseudo-random number as a first response and a second challenge;
verifying the response with the module logic circuit by decrypting the payload based on the first copy of the shared session key, the third random number, and the pseudo-random number;
responding to the pseudo-random number by encrypting a second payload with the module logic chip based on the first copy of he shared session key and the pseudo-random number and providing the encrypted second payload and the pseudo-random number as a second response; and
verifying the second challenge by decrypting the encrypted second payload based on the second copy of the shares session key and the pseudo-random number.

14. The method of claim 13, further comprising:
generating a preliminary encrypted message by encrypting a preliminary payload with the module logic circuit based on the third random number and the first copy of the shared session key; and
decrypting the preliminary encrypted message with the memory device based on the third random number and the second copy of the shared session key.

15. The method of claim 11, further comprising enabling a feature of the memory device, the module logic circuit or combinations thereof responsive to authenticating the module logic chip with the memory device and the memory device with the module logic chip.

16. The method of claim 11, further comprising:
generating the first copy of the shared session key using a secure hash algorithm (SHA) circuit on the module logic circuit; and
generating the second copy of the shared session key using a SHA circuit on the memory device.

17. An apparatus comprising:
a memory device comprising a memory authentication logic circuit configured to store a first copy of a secret key and configured to generate a first random number; and
a module logic chip comprising:
a module authentication logic circuit configured to store a second copy of the secret key;
a random number generator configured to generate a second random number as part of an authentication operation,
wherein as part of the authentication operation the memory authentication logic circuit and module authentication logic circuit are configured to authenticate each other based, in part, on the the first and the second random numbers and the first and the second copies of the secret key.

18. The apparatus of claim 17, wherein as part of the authentication operation the memory authentication logic circuit is configured to generate a first copy of a session key based on the first and the second random numbers and the first copy of the secret key,
wherein as part of the authentication operation the module authentication logic circuit is configured to generate a second copy of the session key based on the first and the second random numbers and the second copy of the secret key.

19. The apparatus of claim 18, wherein the module authentication logic circuit is configured to generate a memory challenge based on a third random number generated by the random number generator,
wherein the memory authentication logic circuit is configured to respond to the memory challenge by generating a first encrypted message as a memory response based, in part, on the first copy of the session key, and generate a pseudo-random number as a module challenge,
wherein the module authentication logic circuit is configured to authenticate the memory device by verifying the memory response based on the second copy of the session key and generate a module response by generating a second encrypted message based, in part on the second copy of the session key and the memory response, and
wherein the memory authentication logic circuit is configured to authenticate the module by verifying the module response based on the first copy of the session key.

20. The apparatus of claim 17, wherein the authentication operation is performed responsive to authentication between the module authentication logic circuit and a host device.

21. The apparatus of claim 17, wherein the first copy of the secret key and the second copy of the secret key were loaded onto the apparatus in an initial trusted environment.
